(19) United States
(12) Patent Application Publication
(10) Pub. No.: US 2024/0005242 A1
(43) Pub. Date: Jan. 4, 2024

(54) DYNAMIC FEDERATED WORKFLOW PROGRAMMING MANAGEMENT

(71) Applicant: INTERNATIONAL BUSINESS MACHINES CORPORATION, ARMONK, NY (US)

(72) Inventors: Allen Vi Cuong Chan, Markham (CA); Jacob Ryan Jepperson, St. Paul, MN (US); A A Kasun Laksandu Attanapola, Kanata (CA); Matthew Warta, Round Rock, TX (US); Justin Webber, Austin, TX (US)

(21) Appl. No.: 17/809,911

(22) Filed: Jun. 30, 2022

(51) Int. Cl. G06Q 10/06; G06N 20/00

(52) U.S. Cl. CPC G06Q 10/0633; G06Q 10/063114; G06N 20/00; G06Q 10/06316

(57) ABSTRACT

A system, method, and computer program product dynamically manage automated workflows. The method includes receiving, from at least one user, a framework of an automated workflow that includes a set of tasks. The method further includes constraining the set of tasks by determining a required order of some of the set of tasks and assigning tasks of the set of tasks to respective roles of the plurality of users. The method also includes receiving assigning assignments of respective responsible users to the respective roles during execution of the workflow. The method also includes receiving subtasks for respective tasks from respective responsible users during execution of the workflow.

### BACKGROUND

There is a growing market for low-code applications. Low-code applications are software building tools that allow people to build software applications with minimal software experience. For example, low-code software applications enable a user to select between a finite number of predetermined functions in specific constrained ways, in response to which the low-code software application compiles pre-constructed programming modules that correlate to these selected functions in order to generate the automation desired by the user.

### SUMMARY

Aspects of the present disclosure relate to a method, system, and computer program product relating to a federated approach to programming workflow solutions. For example, the method includes receiving, from at least one user, a framework of an automated workflow that includes a set of tasks. The method further includes constraining the set of tasks by determining a required order of some of the set of tasks and assigning tasks of the set of tasks to respective roles of the plurality of users. The method also includes receiving assigning assignments of respective responsible users to the respective roles during execution of the workflow. The method also includes receiving subtasks for respective tasks from respective responsible users during execution of the workflow. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A depicts a conceptual diagram of an example system in which controller may manage a federated programming approach for workflow design.

FIG. 1B depicts an example framework of a workflow as generated using the controller of FIG. 1A.

FIG. 1C depicts an example finalized workflow of FIG. 1B after users have updated it.

FIG. 2 depicts a conceptual box diagram of example components of the controller of FIG. 1A.

FIG. 3 depicts an example high-level flowchart by which the controller of FIG. 1A may dynamically manage the federated programming of the workflow.

FIG. 4 depicts an example detailed flowchart by which the controller of FIG. 1A may dynamically manage the federated programming of the workflow.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to federated programming, while more particular aspects of the present disclosure relate to dynamically (and in real-time) managing this federated programming where the automation begins without a full constrained workflow. While the present disclosure is not necessarily limited to such applications, various aspects of the disclosure may be appreciated through a discussion of various examples using this context.

Conventional workflow modeling solutions help users and organizations model and workflows (e.g., integration flows, business process, case management). As used herein, a workflow includes a business act that can be automated, such approving a purchase, sending a product, deploying an asset, or the like. For example, a conventional workflow management solution typically includes a workflow designer mapping out each and every stage of a workflow, so that the workflow can then be deployed and automated. In order to do these things in a helpful manner, the workflow designer therefore is required to know the business domain, know the resources that can be conclusively committed to the workflow, and be able to specify all technical details to meaningfully utilize the conventional workflow management solution. This process is difficult as it usually involves interviewing with multiple subject-matter experts (SMEs), multiple managers (e.g., or other people that can determine the responsibilities and bandwidth of various people that have tasks or responsibilities within the workflow, so that dependencies can be evaluated as realistic or unrealistic depending upon the determined responsibilities and bandwidth), line-of-business owners (e.g., to determine requirements for the workflow to be a success), and the like to come up with the definition of the entire process. Once determined, the conventional workflow management solution can be “automated,” which is to say that the steps of the workflow can be execute with minimal or no oversight to complete the process. Automating the workflow can include placing an order, approving an order/request/requisition, executing a computing algorithm, weighing factors in predetermined ways, informing users when they have upcoming decision points (or upcoming due dates for submitted needed datapoints), requesting updates from users that have current tasks, sending alerts indicating that a task is behind schedule, or the like.

However, even advancements in low code authoring techniques (and also with including default values in some instances), conventional workflow management solutions typically require numerous people to be consulted and provide buy-in in order for the conventional workflow solution to define a workflow that can be successfully automated. Put differently, conventional workflow management solutions typically require rigid and comprehensive workflow before they can begin, where this process of providing comprehensive constraining information can be an error-prone and cumbersome process. For example, a conventional workflow management solution may only be ready to “run” once it has an end-to-end workflow designed and defined, where each step and interdependency is known ahead of time. Further, if inevitably something changes once the workflow in underway, each change typically requires the developer to go back to the workflow designer and make adjustments.

Aspects of this disclosure provide the ability to solve or otherwise address these failings of conventional workflow management solutions. For example, aspects of this disclosure relate to enabling users to flexibly define workflows and then dynamically update tasks and monitor progress in real-time as the workflow is underway. One or more computing devices that include one or more processing units executing instructions stored on one or more memories may provide the functionality that addresses these problems, where said computing device(s) are herein referred to as a controller. This controller enables the participants within the workflow (e.g., the users that are assigned to various tasks) to make changes to their tasks (e.g., changing dates, adding tasks, modifying tasks) within the flexible framework. In this way the controller minimizes the amount of time that it takes for the initial workflow to be created, as the initial user creating the workflow is enabled to defer the creation/finalization of some tasks to a later time for other people to create. Further, the controller enables the workflow management process to be more robust as it can evolve to various developments organically (e.g., by users modifying their own tasks) rather than require a full rework of the process in the manner of conventional workflow management solutions.

Specifically, the controller may enable an ability to “crowdsource” a workflow automation definition phase, where numerous people come together in a federated approach to progressively/iteratively define the workflow as the workflow is being executed. For example, the controller enables individual tasks to be defined (e.g., fully detailed and specified in a comprehensive manner that may be required to complete the workflow, even as it wasn't realized at a time when the initial workflow was complete as a satisfactory framework) after the workflow has started automating. As such, the controller enables the deferment of the definition of some workflow tasks to the users that will eventually be responsible for these tasks (e.g., even as these specific responsible users may not be identified to start the workflow automation). In this way, aspects of this disclosure enable the subject matter experts that will be executing the tasks to determine what tasks to do (and how to do them) rather than these tasks being (often poorly) defined up-front by a user that starts the project (where that user might not be an SME of each subject area).

Further, the controller may follow the workflow process in real-time to optimize the process. For example, the controller may track real-time progress of each task as it is being completed, such as by tracking what users are currently doing on their user devices, tracking the schedules of users, tracking upcoming commitments of the users, and the like. Where the controller detects that a data flow or work from a user is currently deviating from a current workflow (and/or where any factor has more than a threshold amount of risk of deviating from a current workflow), the controller analyzes this deviation to determine whether or not deviation improves or hurts the efficiency of the workflow and react accordingly.

For example, the controller may use a neural network or the like to compare the deviation against historical versions of similar workflows to determine how good or bad the deviation is. The controller may evaluate this based on a number of criteria, such as timeliness, reliability, accuracy, cost, or the like. Where the controller determines that the deviation is negative (e.g., that it reduces timeliness, reliability, accuracy, cost, or the like), the controller may execute a remedial action. This may include the controller alerting one or more users of the deviation, suggesting a reworking of the workflow, identifying another resource/action/user intervention that may smooth out/counteract this deviation, or the like.

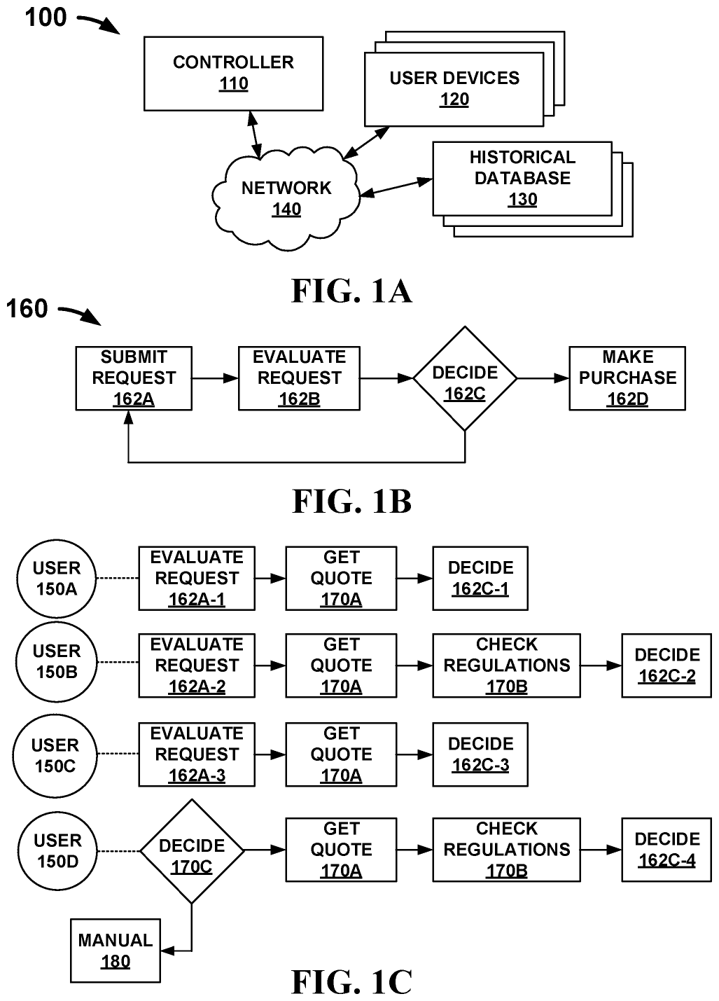

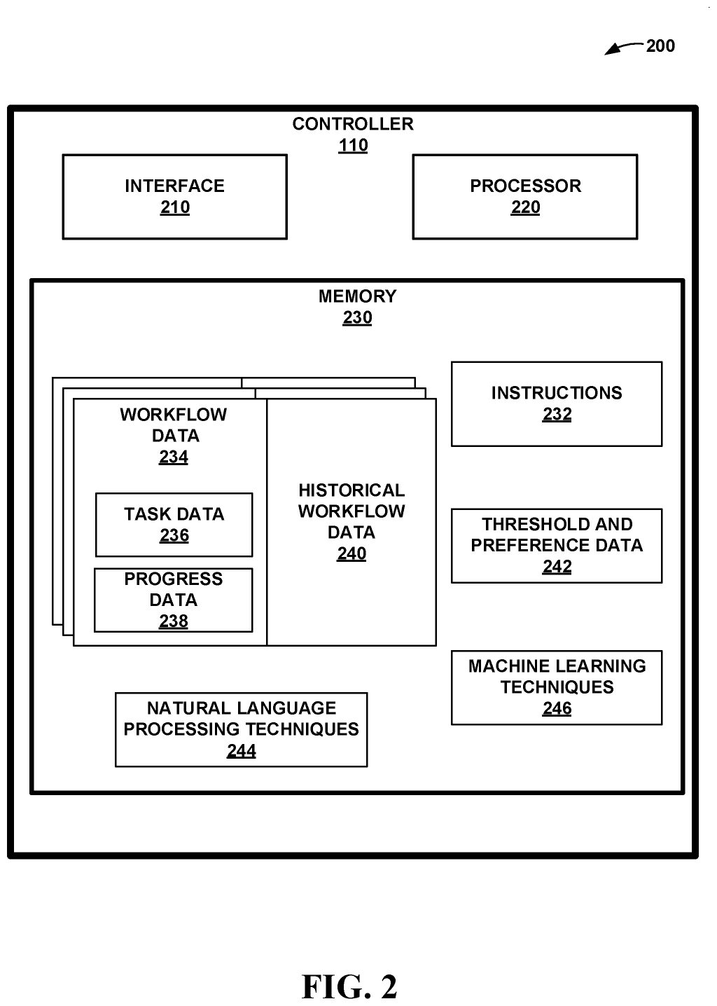

For example, FIG. 1A depicts environment 100 in which controller 110 manages real-time workflow. Controller 110 manages real-time workflow as the workflow is being automated and augmented by a plurality of users of an organization. As depicted in FIG. 1A, this may include controller 110 interacting with users via their user devices 120, which may be computing devices such as laptops or desktops. Controller 110 may include a processor coupled to a memory (as depicted in FIG. 2) that stores instructions that cause controller 110 to execute the operations discussed herein. Though controller 110 is depicted as being structurally distinct from user devices 120, in some embodiments controller 110 may share some computing components with user devices 120. For example, in some embodiments, individual instances of controller 110 may be hosted on some or each user device 120, such that users can interact with these instances (and relative data can be sent back to a centralized location for the analysis and management described herein).

Controller 110 enables users to start an automated workflow using user devices 120. For example, as used herein workflows include business and/or technical operations that can be automated, such as analysis-related actions (e.g., weighing options against predetermined criteria based on various thresholds), schedule related actions (e.g., informing users of upcoming tasks), computing-related actions (e.g., calling programs, executing programs, deploying programs to given environments), purchase-related actions (e.g., approving/rejecting purchase requests), or the like. As discussed herein, conventional processes that involves automation typically require that the automation process be fully constrained before the automation is set in motion. However, controller 110 enables users to start this automated workflow in response to the users sending in a sufficient framework of the full workflow.

For example, as used herein, the framework of the full workflow may include a final step (e.g., a purchase order being approved or disproved, a software-as-a-service product being deployed to a “production” environment, or the like), and required intermediary tasks that are needed to execute and/or arrive at that final step. These intermediary tasks may be loosely constrained. For example, in certain embodiments some (or in other embodiments all) tasks may have no “order” that corresponds to the respective tasks, such that there is no defined order (e.g., first, second, third) in which the tasks must be executed but rather the only requirement is that the tasks be executed prior to the final step. In some examples, one or more tasks may be constrained by predetermined calendar dates, such as dates at which these tasks must be done (or must reach certain milestones). Further, the tasks may be constrained in that they are assigned to a set of users. For example, a task may be assigned to a single user, or a department of users, or a single team of users (e.g., a set of people that have a certification as identified by controller 110), or the like.

In some examples, a single user may provide the framework of the full workflow via one of user devices 120, though in other examples two or more users may collaborate in providing the framework of the full workflow. For example, two users may be working simultaneously on a single instance of a workflow management program provided by controller 110 via two (or more) user devices 120, generating and constraining tasks to arrive at the framework of the full workflow. In other examples, a first user may generate a draft framework and send it to another user for review, and once the second user updates and/or approves the framework, controller 110 begins automating the full workflow.

Controller 110 may be configured to check whether or not the submitted framework of the full workflow is sufficiently complete. For example, controller 110 may not accept a workflow if controller 110 detects that the submitted workflow has some clerical or detail-oriented mistake, such as a task that is not assigned to a group of users, or a workflow that has no final step (e.g., nothing to indicate the conclusion of the automation), or the like. In some examples, controller 110 may be configured to reject workflows if the workflows do not follow organizational or industry regulations. For example, controller 110 may identify if a workflow does not include an approval step that is required by the respective organization, and/or controller 110 may identify if a workflow does not include a logging step as required by industry regulations. If controller 110 detects that a submitted framework of a workflow is incomplete, controller 110 may reject the request to begin automating the workflow, and may also indicate a source of a detected insufficiency.

Users may force controller 110 to automate the workflow even where controller 110 returns an error. For example, controller 110 may be “overruled” (e.g., forced to automate) in response to receiving authorization from a designated user. Specifically, say that controller 110 determines that a framework is unsatisfactory because it does not include final approval from a manager, controller 110 may be configured to be overruled and start automation in response to receiving pre-emptive approval from that manager.

In some examples, controller 110 further provide suggested constraints to the workflow and/or suggests specific tasks. For example, controller 110 may suggest that certain tasks be included or constrained in certain ways in response to controller 110 determining that these new task or constraints will make the workflow better in some capacity. This may include controller 110 utilizing a neural network or the like to compare details within the provided framework against details of historical frameworks within historical database 130. In this way, controller 110 may determine that it is preferable to have a task approved/designed by a different user, or may determine that a given task should be ordered in a certain way, or the like.

Controller 110 may interact with user devices 120 and historical databases 130 using network 140. Network 140 may include a computing network over which computing messages may be sent and/or received. For example, network 140 may include the Internet, a local area network (LAN), a wide area network (WAN), a wireless network such as a wireless LAN (WLAN), or the like. Network 160 may comprise copper transmission cables, optical transmission fibers, wireless transmission, routers, firewalls, switches, gateway computers and/or edge servers. A network adapter card or network interface in each computing/processing device (e.g., computing devices that host/include user devices 120 and/or historical databases 130) may receive messages and/or instructions from and/or through network 140 and forward the messages and/or instructions for storage or execution or the like to a respective memory or processor of the respective computing/processing device. Though network 140 is depicted as a single entity in FIG. 1A for purposes of illustration, in other examples network 140 may include a plurality of private and/or public networks.

FIG. 1B depicts an example framework of a full workflow 160. As depicted this workflow 160 relates to making a purchase, where workflow 160 includes a set of tasks 162A-162D (collectively, “tasks 162”) including a user submitting a request 162A, users evaluating this request 162B, these users deciding whether to approve the request 162C, and either automatically making the purchase 162D or asking for a new submitted request 162A. Controller 110 may analyze framework for constraints, and identify that people from four departments mush evaluate the request 162B and decide 162C before the purchase can be made 162D, but that there is no particular order in which these four departments evaluate, and further that it does not matter which user from these departments executes this evaluation.

Controller 110 enables users to assign tasks 162 to themselves (and/or to other respective users), and to further define new subtasks associated with these tasks 162. Controller 110 enables this assignment and subtask generation while the workflow is currently being automated. For example, FIG. 1C depicts new subtasks 170A-170C (collectively, “subtasks 170”) generated by respective users 150A-150D (collectively, “users 150”), where most of FIG. 1C might have been generated following workflow 160 being automated. Once workflow 160 is automated, controller 110 receives assignments of users 150 to respective tasks 162 (e.g., such that these assigned users 150 were identified to be the users 150 that are responsible for those tasks 162). For example, a single manager may have assigned these users 150 to respective tasks 162, and/or respective users 150 may have signed up for respective tasks 162, or the like.

Controller 110 enables users 150 to add subtasks 170A as they define how tasks 162 are to be executed within workflow 160. For example, user 150A may decide to fully automate their tasks 162, with a first automated task of evaluating request 162A-1 (which is a portion of task 162A that is assigned to user 150A). Subtask 162A-1 may define that controller 110 is to gather user-specified data points (e.g., specs of the purchase, a role of the person who will be using the purchase, etc.). User 150A also specifies a new subtask of getting a quote 170A, as well as subtask 162C-1 (which is a portion of task 162C that is assigned to user 150A) in which user 150A defines various thresholds at which the decision will be approved or denied. Once user 150A provides these subtasks to automate their portion of tasks 162, controller 110 may automate this full process of subtasks 162A-1, 170A, and 162C-1.

Similarly, user 150B may choose (e.g., assign themselves within a user interface) to design another automation process as another approver. For example, user 150A may be approving a type of purchase request on behalf of a first division, while user 150B is approving the type of purchase request on behalf of a second division, such for all such future purchase requests that the provided automation workflow is executed. However, user 150B may elect to have slightly different automation tasks/subtasks to represent their approval. Controller 110 enables these differing automation processes, even after the automation process is “live.”

For example, as depicted, user 150B may also choose to set up evaluate request task 162A-2, get quote task 170A, and decide task 162C-2, where each of these requests are similar (or perhaps identical) to how user 150A did. However, controller 110 may detect that user 150B further decides to add subtask check regulations 170B. This subtask may include controller 110 verifying that details of the purchase request align with various internal and external policies and/or regulations. Controller 110 may enable user 150C to directly copy the tasks 162 and subtasks 170 of user 150A, with evaluate request tasks 162A-3 and get quote subtask 170A and decide task 162C-3, so that user 150C does not need to re-do all of these operations. In this way, controller 110 enables users 150 to set up their automation steps to be different based on their expertise as to what is required to succeed within the workflow.

In some examples, controller 110 may receive operations that can “kick” the workflow out of an automated mode and into a manual mode. For example, user 150D may set up an initial subtask decision 170C which causes controller 110 to determine whether the process is to require a manual task 180 or continue along with automated tasks (e.g., tasks 170A, 170B, 162C-4, which may all be automated tasks similar to those from user 150B). This decision task 170C may be an automated determination, such that if controller 110 determines that the submitted request passes a threshold of decision task 170C then the automated workflow will continue being automated, whereas (if the submitted request “fails” the threshold) the workflow will “pause” automation until user 150D (or someone who can act on behalf of user 150D) manually approves of the purchase request. For example, user 150D may set up decision task 170C to require manual approval if a dollar amount of the submitted request is over a threshold amount, or if the purchase request is from certain employees, or if the purchase is for certain types of items, or the like. In this way, controller 110 may be configured to jump between an automated workflow and manual operations, even as the automated process may have been defined and then started without any manual steps (e.g., where user 150D did not “create” the “decide 170C” task and “manual operation 180” branch until after the automation had begun).

Further, as discussed herein, controller 110 may execute the automated tasks 162 and subtasks 170 from one user 150 prior to other users 150 defining their respective tasks 162 and subtasks 170. For example, controller 110 can execute all automation from user 150A prior to any other users 150B, 150C, 150D providing their automation tasks, so long as this is not blocked by the workflow 160 framework. However, until all automation tasks 162 from all users 150 are provided, controller 110 may hold workflow 160 from a final step (e.g., making purchase 162D).

As described above, controller 110 may include or be part of a computing device that includes a processor configured to execute instructions stored on a memory to execute the techniques described herein. For example, FIG. 2 is a conceptual box diagram of such computing system 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with user device 120, historical databases 130, or the like. Interface 210 may include one or more network interface cards, such as Ethernet cards and/or any other types of interface devices that can send and receive information. Any suitable number of interfaces may be used to perform the described functions according to particular needs.

As discussed herein, controller 110 may be configured to manage dynamic workflow automation. Controller 110 may utilize processor 220 to dynamically generate workflows and respond to detect workflow progress in this way. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to manage dynamic workflow automation accordingly.

Processor 220 may manage dynamic workflow automation according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may manage dynamic workflow automation as described herein according to instructions 232 of one or more applications (e.g., software applications) stored in memory 230 of controller 110.

In addition to instructions 232, in some examples gathered or predetermined data or techniques or the like as used by processor 220 to manage dynamic workflow automation as described herein may be stored within memory 230. For example, memory 230 may include information described above that is gathered from environment 100. Specifically, as depicted in FIG. 2, memory 230 may include workflow data 234, which itself includes task data 236 and progress data 238. For example, workflow data 234 may include the workflow as generated by a user. Further, task data 236 may include data regarding which users are assigned to which tasks, constraints on tasks (e.g., an order of tasks, or a deadline for tasks, or the like), points where an automation of the workflow may (or definitively does) require a manual step, or the like. Further, workflow data 234 includes progress data 238, which is to say real-time manual process compared to the implemented workflow. For example, the automated workflow may include some steps where controller 110 is to wait until a certain thing happens at a certain date in the future. In response to such a step, controller 110 may track the progress of this certain thing happen as progress data 238, and may therein act accordingly if this progress data 238 suggested a concerning negative deviation that warrants addressing.

Further, memory 230 includes historical workflow data 240 (e.g., from historical databases 130). As depicted, controller 110 may store historical workflow data 240 as it correlates to workflow data 234, therein evaluating differences therebetween. For example, controller 110 may detect a task from historical workflow data 240 that is not within task data 236, and may suggest that this historical task be added to the current workflow to improve results. For another example, controller 110 may evaluate that a form of a historical task is different than a form of a current task of task data 236 (e.g., that the historical task has a different threshold as discussed below, or a different order, or a different user providing a manual check or the like), and if controller 110 has data to support the historical form being superior, controller 110 may recommend updating the current task to be similar to this historical task. Alternatively, controller 110 may simply detect that a form of a historical task is different than a form of a current task, in response to which controller 110 may monitor and compare a performance of both across future iterations to determine which (if either) is superior.

Further, memory 230 may include threshold and preference data 242. Threshold and preference data 242 may include thresholds that define a manner in which controller 110 is to manage the automation of workflows. For example, threshold and preference data 242 may include thresholds at which controller 110 executes various tasks as described above, such as user-provided thresholds. For another example, threshold and performance data 242 may include thresholds at which controller 110 is to suggest modifying the form of a task. For example, controller 110 may be configured to suggest modifying the form of a task only in response to determining that the modification would improve a performance of the workflow by a certain amount, where this threshold amount is stored in threshold and performance data 242.

Memory 230 may further include natural language processing (NLP) techniques 244. NLP techniques 244 can include, but are not limited to, semantic similarity, syntactic analysis, and ontological matching. For example, in some embodiments, processor 220 may be configured to analyze natural language data as gathered from user devices 120 and historical database 130 to determine semantic features (e.g., word meanings, repeated words, keywords, etc.) and/or syntactic features (e.g., word structure, location of semantic features in headings, title, etc.) of natural language data between users to determining a progress of a task, and/or the success of a final workflow. Ontological matching could be used to map semantic and/or syntactic features to a particular concept. For example, controller 110 may use NLP techniques 244 to determine that a task of completing task XYZ by July 31 is in danger of not being completed in response to detecting a user saying that task XYZ is not yet started on July 30.

Memory 230 may further include machine learning techniques 246 that controller 110 may use to improve a process of managing the dynamic generation of workflow automation as described herein over time. Machine learning techniques 246 can comprise algorithms or models that are generated by performing supervised, unsupervised, or semi-supervised training on a dataset, and subsequently applying the generated algorithm or model to manage workflow automation. Using these machine learning techniques 246, controller 110 may improve an ability to dynamically generate workflow automation and then responsively manage that workflow automation. For example, controller 110 may identify over time what variety of tasks should be monitored more or less closely, and may activate agents accordingly across network 140 to do that monitoring. For another example, controller 110 may determine which users (and/or characteristics of users that) tend to develop better automations, and may prioritize sending certain tasks to these users. For another example, controller 110 may determine which users provide better manual interaction with workflows, and may prioritize suggest these users in relevant situations.

Machine learning techniques 246 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques 246 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

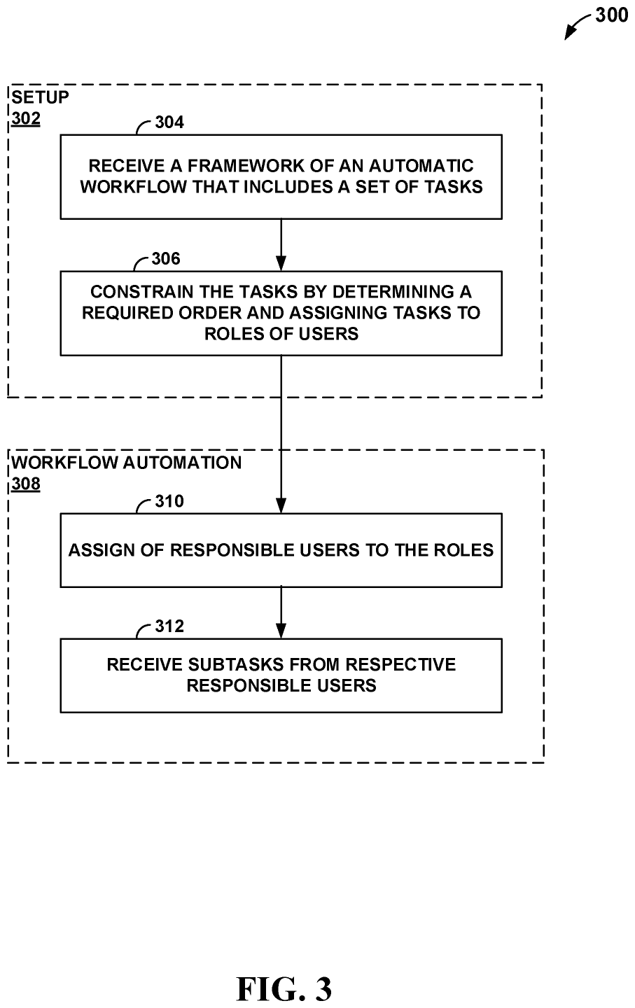

Using these components, controller 110 may dynamically managing automated workflows as discussed herein. For example, controller 110 may manage automated workflow according to flowchart 300 depicted in FIG. 3. Flowchart 300 of FIG. 3 is discussed with relation to FIG. 1A for purposes of illustration, though it is to be understood that other environments with other components may be used to execute flowchart 300 of FIG. 3 in other examples. Further, in some examples controller 110 may execute a different method than flowchart 300 of FIG. 3, or controller 110 may execute a similar method with more or less steps in a different order, or the like.

Controller 110 receives a framework of an automated workflow that includes a set of tasks (304). Controller 110 receives this from at least one user. For example, in some situations numerous users may collaborate simultaneously and/or sequentially to piece together the framework, whereas in other examples a single user may put together this initial framework (that is completed and then dynamically modified as described herein).

Controller 110 constrains the tasks by determining a required order and assigning tasks to roles of users (306). For example, controller 110 may determine a task that must be at the beginning of the automated workflow, and a task that must be at the end of the automated workflow, and/or some tasks in between this beginning and end may be ordered. Further, controller 110 may assign tasks to certain roles of users, where a role of a user includes a job of the user, a department of a user, or the like. In some examples, controller 110 directly assigns tasks to identified users. While a user may provide an initial assignment between roles and tasks, controller 110 may use a machine learning model to suggest different assignments. For example, controller 110 may analyze considerations including geographical locations of users, work histories of users, and collaborations between users in assigning tasks to roles.

Together, the acts of receiving the framework and constraining tasks may define a setup 302 phase. Controller 110 may analyze the framework when a user requests to exit this setup 302 phase. For example, controller 110 may include certain business logic and/or may reference historical databases 130 to analyze if there are any required portions of an initial framework that are missing. If they are missing, controller 110 may autonomously generate them, and/or instruct a user to provide them. Otherwise, controller 110 may enable a user to triggering automation to enter the workflow automation 308 phase.

During execution of the workflow in the workflow automation 308 phase, controller 110 receives assignments of respective responsible users to the respective roles (310). Put differently, controller 110 may enable that each task is either sufficiently complete within the workflow or is assigned to a responsible user with the appropriate respective role for that task. In some examples, where a first user is assigned to one task within the workflow, controller 110 may suggest that a second user (that has been identified by controller 110 as collaborating well with the first user) also be assigned to a corresponding task of workflow. Further, as described herein, controller 110 may look at other factors such as geographical locations, work histories, and the like in assembling a team of users that is predicted to work well together in constructing the workflow. Controller 110 then receives subtasks for respective tasks from these respective users during workflow automation (312). This includes the users specifying exactly how the workflow is to be executed. For example, this may include controller 110 receiving indicates that the workflow might (or definitely does) include manual subtasks, which is tasks that cannot be automated.

Controller 110 then monitors the progress of the workflow. For example, controller 110 monitors for deviations from the workflow. Where controller 110 detects that a real-time progress of an identified task is deviating from the workflow by more than a threshold amount in a negative manner (e.g., being slower, or more expensive, or requiring more computing resources) controller 110 executes a remedial action. This remedial action may include alerting a user, halting the automated workflow, or the like. In some examples, it includes identifying one or more responsible users of department that are related to the identified task (e.g., such that these users were supposed to execute the task, or were supposed to execute other steps that support this task). Controller 110 may further identify that these users currently have a relatively high workload (e.g., using NLP techniques or the like on various chatter between user devices 120), and therein (re)assigning some of all of the identified task to one or more other users of that same department that have a relatively low workload. In some examples, some or all of this may be done autonomously, though in other examples this is executed via a suggestion provided to a manager or the like.

In certain examples, controller 110 determines that a real-time progress is deviating negatively by monitoring actions executing on user devices 120. For example, the workflow may relate to deploying a new software patch, and controller 110 may analyze programming actions of various responsible users to determine that progress on creating this patch is behind a planned date associated with this task. For another example, controller 110 may track a progress as otherwise recorded on/by other project-management software.

In some examples, controller 110 may identify a positive deviation that indicates increased efficiency of the current workflow. For example, controller 110 may determine that a workflow is significantly faster, or more accurate, or more cost-effective than projected (or expected via analysis of historical databases 130). In response to this, controller 110 may identify aspects of the current workflow that correlate with but are different than historical workflows (e.g., different values of same variables), and maybe recommend that other concurrent workflows incorporate the identified aspects. Similarly, controller 110 may constantly be identifying how current variables of the current workflow compare to historical workflows, and recommending modifications that incorporate increased efficiencies of historical workflows.

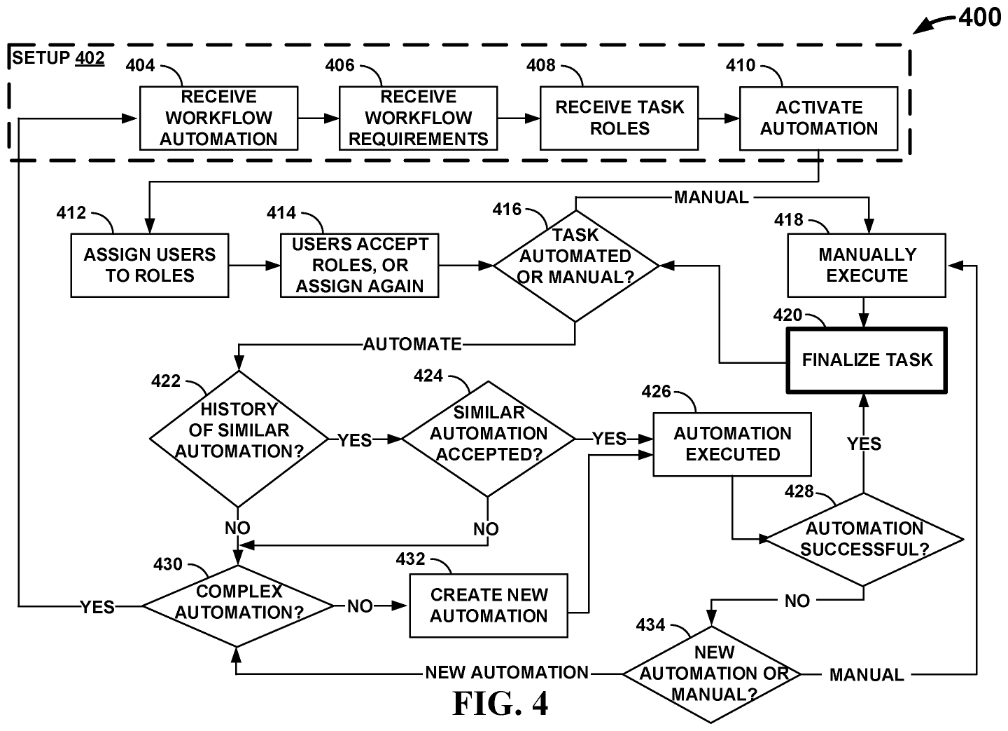

FIG. 4 depicts a more detailed flowchart 400 of dynamically managing autonomous workflows as discussed herein. Flowchart 400 of FIG. 4 is discussed with relation to FIG. 1A for purposes of illustration, though it is to be understood that other environments with other components may be used to execute flowchart 400 of FIG. 4 in other examples. Further, in some examples controller 110 may execute a different method than flowchart 400 of FIG. 4, or controller 110 may execute a similar method with more or less steps in a different order, or the like.

In a setup 402 phase (which is analogous to setup 302 phase), controller 110 receives a high-level workflow automation framework (404), receives workflow requirements (406) such as places where task constrains/workflow specifications can be deferred, receives assignments between tasks and user roles (408), and activates the automation (410). Once automation is live, controller 110 assigns users to roles and therein tasks (412). Controller 110 may do some or all assignments autonomously, or controller 110 may receive these direct assignments/selections. Once assigned, users can either accept these roles or the roles/tasks can be reassigned (414). From here, controller 110 identifies a first task, and determines if it is a manual task or an automated tasks (416). If it is identified as a manual task, controller 110 sends an alert for the task to be manually executed (418), and once this task is finalized (420) controller 110 determines if a next task is identified as being automated or manual 416.

If it is identified as being an automated task, controller 110 determines if there is a history of similar automation (422). If controller 110 determines that there is a history of automation that is similar to the current task (yes branch), controller 110 recommends this historical automation to the user (otherwise controller 110 checks for complex automation (430) as discussed below). If controller 110 determines that the similar automation is acceptable for user (yes branch from 424), controller executes this automation (426) and then checks if this automation is successful (428). If the automation was successful (yes branch from 428), controller 110 determines that this task was finalized (420) and identifies the next task. Otherwise, if controller 110 determines that the automation was not successful (no branch from 428), controller 110 determines if a new automation is to be attempted or if it will be a manual task (434). If it is a manual tasks a user is alerted so that the task can be manually executed (418).

If controller 110 determines via workflow that a new automation is appropriate, controller 110 identifies if it is a new complex automation or a simple automation (430). For example, a complex automation would require a brand new workflow, with new users for new tasks. If controller 110 determines that it is a complex automation (yes branch from 430), controller 110 returns to setup 402 phase. Otherwise controller 110 works with user to create a new automation (432), after which this automation is executed (426) and controller 110 determines if the new automation is successful (428).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from at least one user, a framework of an automated workflow that includes a set of tasks;
constraining the set of tasks by determining a required order of some tasks of the set of tasks and assigning tasks of the set of tasks to a respective roles of the plurality of users;
during execution of the workflow, receiving assignments of respective responsible users to the respective roles; and
during execution of the workflow, receiving subtasks for respective tasks from respective responsible users.

2. The computer-implemented method of claim 1, wherein some subtasks include manual tasks to be executed by the respective responsible users.

3. The computer-implemented method of claim 1, further comprising detecting that a real-time progress of an identified task is deviating from the workflow by more than the threshold amount.

4. The computer-implemented method of claim 3, further comprising taking a remedial action in response to the real-time progress deviating by more than the threshold amount.

5. The computer-implemented method of claim 4, wherein the identified task relates to an identified responsible user of a department, the method further comprising analyzing workloads of the department and identifying that the identified responsible user has a relatively high workload, wherein the remedial action includes assigning work that relates to the identified task to another user of the department that has a relatively low workload.

6. The computer-implemented method of claim 3, wherein detecting that the real-time progress is deviating by more than the threshold amount includes monitoring actions executed on computing devices of the plurality of users.

7. The computer-implemented method of claim 1, further comprising:
autonomously analyzing efficiencies of historical workflows;
autonomously identifying aspects of historical workflows that correlated with increased efficiency; and
autonomously recommending modifications to the workflow that incorporate the aspects.

8. The computer-implemented method of claim 1, further comprising using a machine-learning model to suggest assignments of users to tasks by analyzing considerations including geographical locations of users, work histories of users, and collaborations between users.

9. A system comprising:
a processor; and
a memory in communication with the processor, the memory containing instructions that, when executed by the processor, cause the processor to:
receive, from at least one user, a framework of an automated workflow that includes a set of tasks;
constrain the set of tasks by determining a required order of some tasks of the set of tasks and assigning tasks of the set of tasks to a respective roles of the plurality of users;
during execution of the workflow, receive assignments of respective responsible users to the respective roles; and
during execution of the workflow, receive subtasks for respective tasks from respective responsible users.

10. The system of claim 9, wherein some subtasks include manual tasks to be executed by the respective responsible users.

11. The system of claim 9, the memory containing additional instructions that, when executed by the processor, cause the processor to detect that a real-time progress of an identified task is deviating from the workflow by more than a threshold amount.

12. The system of claim 11, the memory containing additional instructions that, when executed by the processor, cause the processor to take a remedial action in response to the real-time progress deviating from the workflow by more than the threshold amount.

13. The system of claim 12, wherein the identified task relates to an identified responsible user of a department, the memory containing additional instructions that, when executed by the processor, cause the processor to analyze workloads of the department and identifying that the identified responsible user has a relatively high workload, wherein the remedial action includes assigning work that relates to the identified task to another user of the department that has a relatively low workload.

14. The system of claim 12, wherein detecting that the real-time progress deviates from the workflow by more than the threshold amount includes monitoring actions executed on computing devices of the plurality of users.

15. The system of claim 9, the memory containing additional instructions that, when executed by the processor, cause the processor to:
autonomously analyze efficiencies of historical workflows;
autonomously identify aspects of historical workflows that correlated with increased efficiency; and
autonomously recommend modifications to the workflow that incorporate the aspects.

16. The system of claim 9, the memory containing additional instructions that, when executed by the processor, cause the processor to use a machine-learning model to suggest assignments of users to tasks by analyzing considerations including geographical locations of users, work histories of users, and collaborations between users.

17. A computer program product, the computer program product comprising a computer readable storage medium having program instructions embodied therewith, the program instructions executable by a computer to cause the computer to:
receive, from at least one user, a framework of an automated workflow that includes a set of tasks;
constrain the set of tasks by determining a required order of some tasks of the set of tasks and assigning tasks of the set of tasks to a respective roles of the plurality of users;
during execution of the workflow, receive assignments of respective responsible users to the respective roles; and
during execution of the workflow, receive subtasks for respective tasks from respective responsible users.

18. The computer program product of claim 17, wherein some subtasks include manual tasks to be executed by the respective responsible users.

19. The computer program product of claim 17, the computer readable storage medium containing additional program instructions that, when executed by the computer, cause the computer to detect that a real-time progress of an identified task is deviating from the workflow by more than a threshold amount.

20. The computer program product of claim 19, the computer readable storage medium containing additional program instructions that, when executed by the computer, cause the computer to take a remedial action in response to the real-time progress deviating from the workflow by more than the threshold amount.
